(19) United States
(12) Patent Application Publication
(10) Pub. No.: US 2025/0294484 A1
(43) Pub. Date: Sep. 18, 2025

(54) ACTIVATING OR DEACTIVATING COMMUNICATIONS ON A CELL

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 19/060,442

(22) Filed: Feb. 21, 2025

Related U.S. Application Data
(60) Provisional application No. 63/566,770, filed on Mar. 18, 2024.

(51) Int. Cl. H04W 56/00; H04L 27/02; H04W 74/0833; H04W 76/20

(52) U.S. Cl. CPC H04W 56/0015; H04L 27/02; H04W 74/0833; H04W 76/20

(57) ABSTRACT

Apparatuses and methods for activating or deactivating communications on a cell. A method for a user equipment (UE) includes receiving first information indicating reception occasions for a first signal or a first channel, receiving second information indicating time resources or frequency resources for transmission of a second signal or a second channel, and receiving the first signal or the first channel. The method further includes determining to transmit the second signal or the second channel based on the reception of the first signal or channel and transmitting the second signal or the second channel.

### CROSS-REFERENCE TO RELATED AND CLAIM OF PRIORITY

The present application claims priority under 35 U.S.C. § 119 (e) to U.S. Provisional Patent Application No. 63/566,770 filed on Mar. 18, 2024, which is hereby incorporated by reference in its entirety.

### TECHNICAL FIELD

The present disclosure relates generally to wireless communication systems and, more specifically, the present disclosure is related to apparatuses and methods for activating or deactivating communications on a cell.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to activating or deactivating communications on a cell.

In one embodiment, a method for a user equipment (UE) is provided. The method includes receiving first information indicating reception occasions for a first signal or a first channel, receiving second information indicating time resources or frequency resources for transmission of a second signal or a second channel, and receiving the first signal or the first channel. The method further includes determining to transmit the second signal or the second channel based on the reception of the first signal or channel and transmitting the second signal or the second channel.

In another embodiment, a UE is provided. The UE includes a transceiver configured to receive first information indicating reception occasions for a first signal or a first channel, receive second information indicating time resources or frequency resources for transmission of a second signal or a second channel, and receive the first signal or the first channel. The UE further includes a processor operably coupled to the transceiver. The processor is configured to determine an indication for transmission of the second signal or the second channel based on the reception of the first signal or channel. The transceiver is further configured to transmit the second signal or the second channel.

In yet another embodiment, a base station is provided. The base station includes a transceiver configured to transmit first information indicating reception occasions for a first signal or a first channel, transmit second information indicating time resources or frequency resources for reception of a second signal or a second channel, transmit the first signal or the first channel, and receive the second signal or channel. The base station further includes a processor operably coupled to the transceiver. The processor is configured to determine a presence of a UE operating in a RRC IDLE state based on the reception of the second signal or channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical downlink control channel (PDCCH) in a subframe according to embodiments of the present disclosure;

FIG. 9 illustrates an example of a receiver structure for PDCCH in a subframe according to embodiments of the present disclosure;

FIG. 10 illustrates diagrams of example satellite footprints according to embodiments of the present disclosure;

FIG. 11 illustrates a flowchart of an example UE procedure for receiving an early indication (EI) according to embodiments of the present disclosure;

FIG. 12 illustrates an example timeline for transmission/reception of an EI according to embodiments of the present disclosure;

FIG. 13 illustrates a flowchart of an example UE procedure for transmitting a physical random access channel (PRACH) according to embodiments of the present disclosure; and

FIG. 14 illustrates a flowchart of an example UE procedure for starting a random access procedure according to embodiments of the present disclosure.

### DETAILED DESCRIPTION

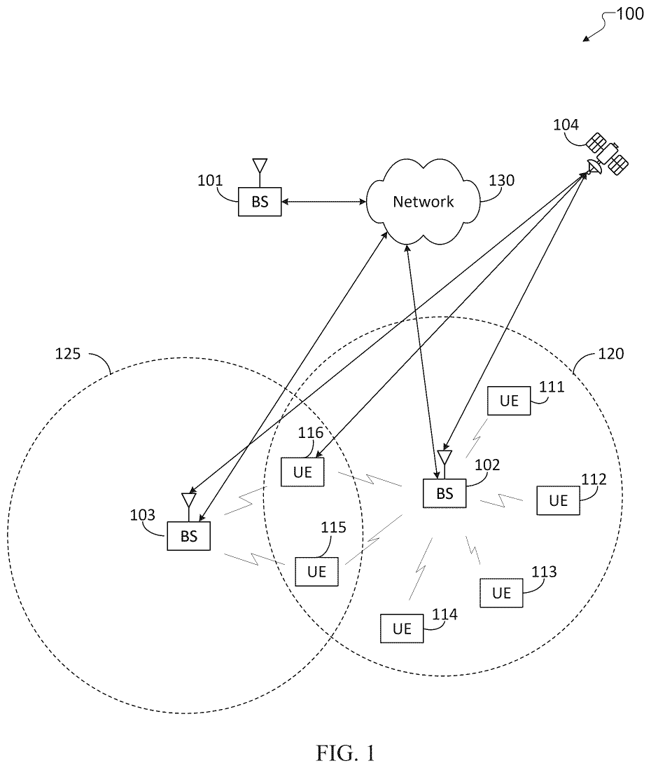

FIGS. 1-14 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v18.1.0, “NR; Physical channels and modulation;” [REF2] 3GPP TS 38.212 v18.1.0, “NR; Multiplexing and channel coding;” [REF3] 3GPP TS 38.213 v18.1.0, “NR; Physical layer procedures for control;” [REF4] 3GPP TS 38.214 v18.1.0, “NR; Physical layer procedures for data;” [REF5] 3GPP TS 38.321 v18.0.0, “NR; Medium Access Control (MAC) Protocol Specification;” and [REF6] 3GPP TS 38.331 v18.0.0, “NR; Radio Resource Control (RRC) Protocol Specification.”

FIGS. 1-14 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for activating or deactivating communications on a cell. In certain embodiments, one or more of the BSs 101-103 include circuitry, programing, or a combination thereof to support activating or deactivating communications on a cell.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

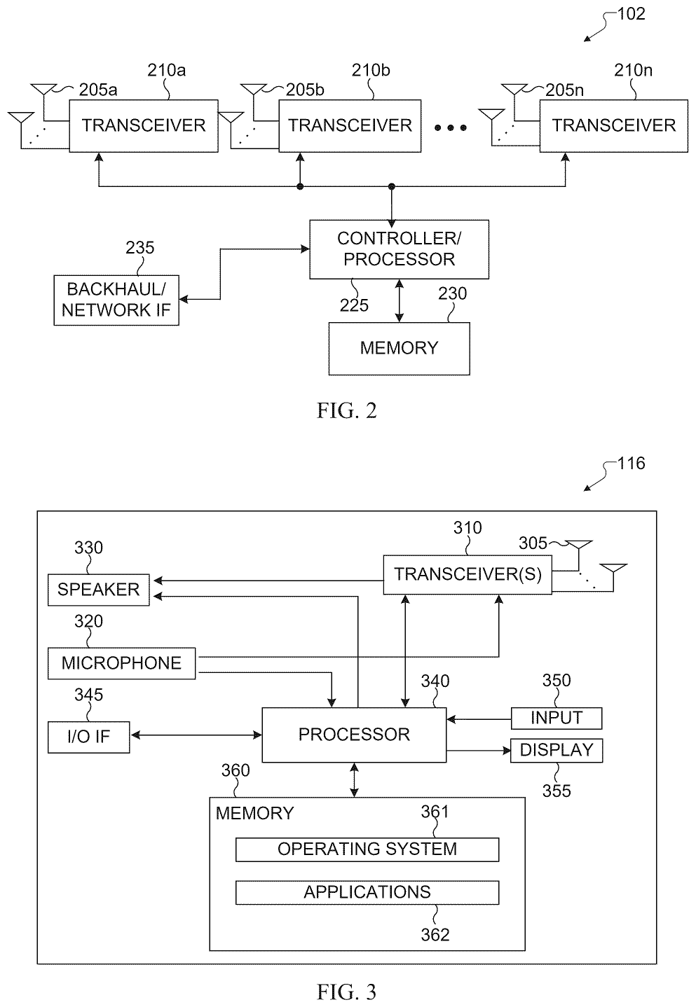

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for activating or deactivating communications on a cell. Any of a wide variety of other functions could be supported in the gNB 102 by the controller/processor 225.

The controller/processor 225 is also capable of executing programs and other processes resident in the memory 230, such as processes to support activating or deactivating communications on a cell. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for activating or deactivating communications on a cell as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

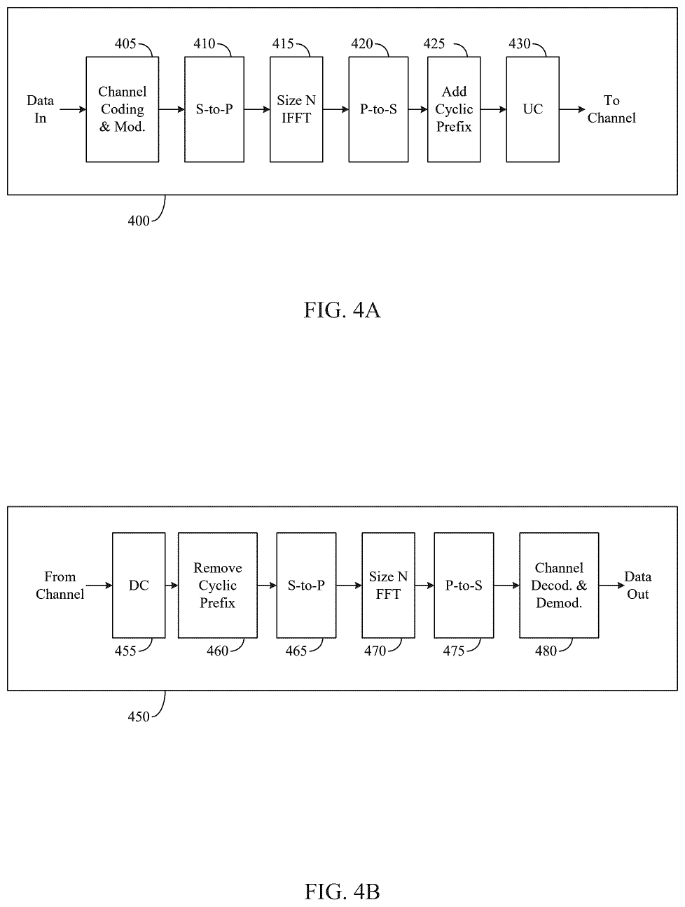

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for activating or deactivating communications on a cell as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

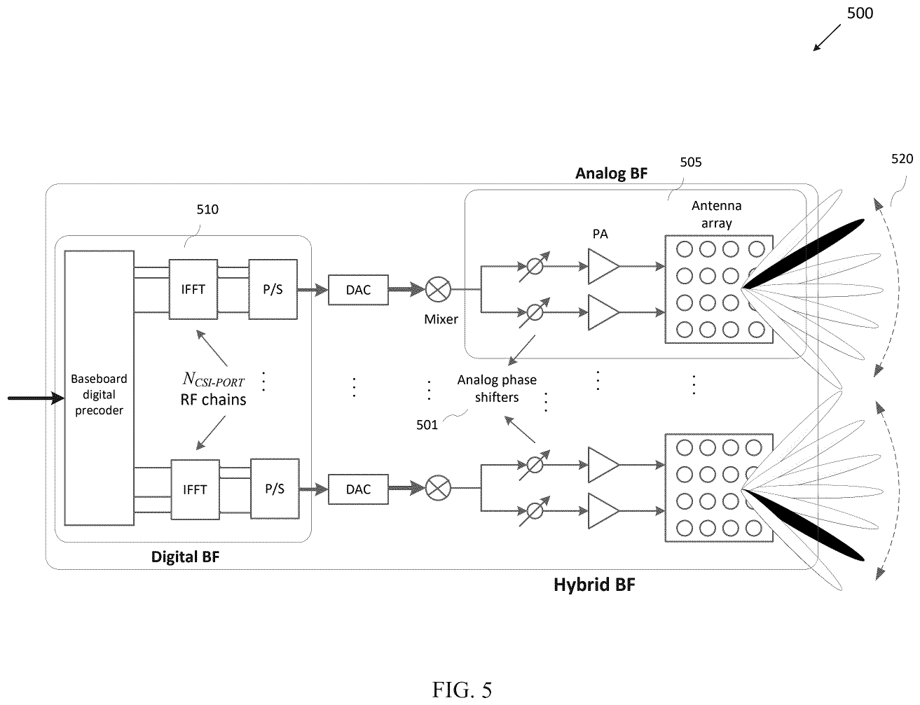

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the 02 absorption loss around 60 GHz frequency (˜10 dB additional loss per 100 m distance), a larger number and narrower analog beams (hence a larger number of radiators in the array) are essential to compensate for the additional path loss.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In the following, an italicized name for a parameter implies that the parameter is provided by higher layers.

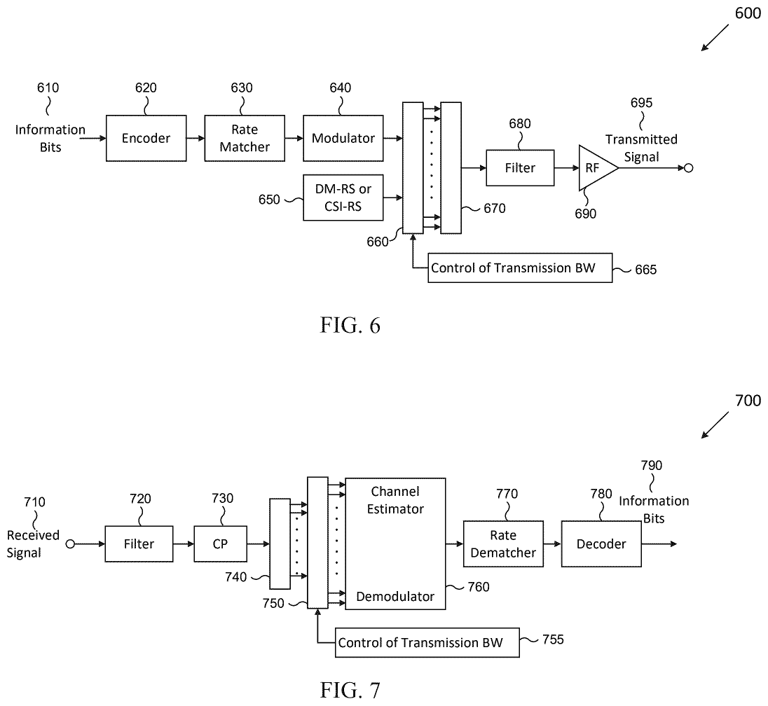

FIG. 6 an example of a transmitter structure 600 for PDSCH in a subframe according to embodiments of the present disclosure. For example, transmitter structure 600 can be implemented in gNB 103 of FIG. 1. This example is for illustration only and other embodiments can be used without departing from the scope of the present disclosure.

Information bits, such as DCI bits or data bits 610, are encoded by encoder 620, rate matched to assigned time/frequency resources by rate matcher 630, and modulated by modulator 640. Subsequently, modulated encoded symbols and demodulation reference signal (DM-RS) or CSI-RS 650 are mapped to REs 660 by RE mapping unit 665, an inverse fast Fourier transform (IFFT) is performed by filter 670, a cyclic prefix (CP) is added by CP insertion unit 680, and a resulting signal is filtered by filter 690 and transmitted by a radio frequency (RF) unit 695.

FIG. 7 illustrates an example of a receiver structure 700 for PDSCH in a subframe according to embodiments of the present disclosure. For example, receiver structure 700 can be implemented by the UE 116 of FIG. 3. This example is for illustration only and other embodiments can be used without departing from the scope of the present disclosure.

A received signal 710 is filtered by filter 720, a CP removal unit removes a CP 730, a filter 740 applies a fast Fourier transform (FFT), RE de-mapping unit 750 de-maps REs selected by bandwidth (BW) selector unit 755, received symbols are demodulated by a channel estimator and a demodulator unit 760, a rate de-matcher 770 restores a rate matching, and a decoder 580 decodes the resulting bits to provide information bits 790.

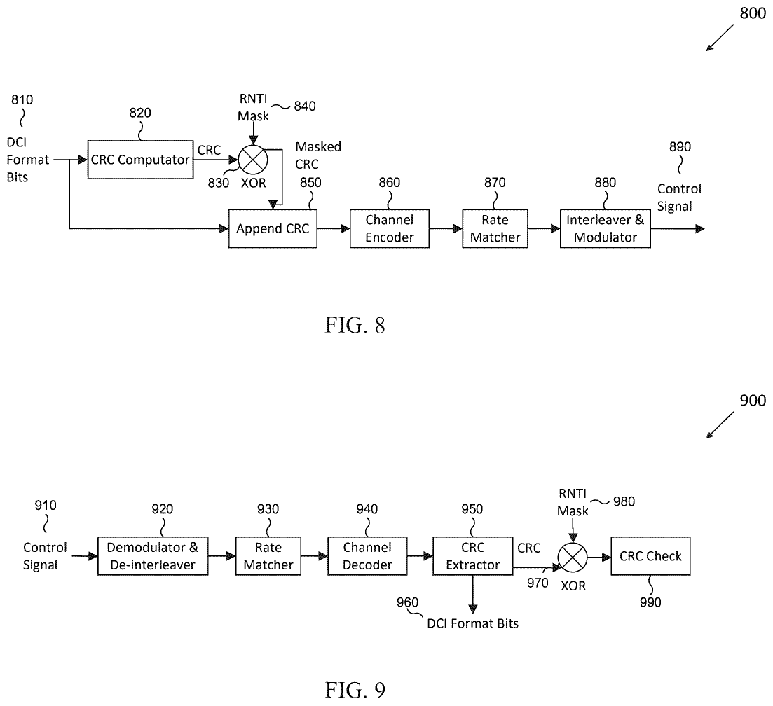

FIG. 8 illustrates an example of a transmitter structure 800 for PDCCH in a subframe according to embodiments of the present disclosure. For example, transmitter structure 800 can be implemented in gNB 102 of FIG. 1. This example is for illustration only and other embodiments can be used without departing from the scope of the present disclosure.

FIG. 9 illustrates an example of a receiver structure 900 for PDCCH in a subframe according to embodiments of the present disclosure. For example, receiver structure 900 can be implemented by any of the UEs 111-116 of FIG. 1. This example is for illustration only and other embodiments can be used without departing from the scope of the present disclosure.

A received control signal 910 is demodulated and de-interleaved by a demodulator and a de-interleaver 920. A rate matching applied at a gNB transmitter is restored by rate matcher 930, and resulting bits are decoded by decoder 940. After decoding, a cyclic redundancy check (CRC) extractor 950 extracts CRC bits and provides DCI format information bits 960. The DCI format information bits are de-masked 970 by an XOR operation with a radio network temporary identifier (RNTI) 980 (when applicable) and a CRC check is performed by unit 990. When the CRC check succeeds (check-sum is zero), the DCI format information bits are regarded to be valid. When the CRC check does not succeed, the DCI format information bits are regarded to be invalid.

DL transmissions or UL transmissions can be based on an OFDM waveform including a variant using DFT precoding that is known as DFT-spread-OFDM that is typically applicable to UL transmissions.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}· 15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 v18.1.0, “NR; Physical channels and modulation”, and 3GPP TS 38.213 v18.1.0 [REF3] “NR; Physical Layer procedures for control”.

For each DL bandwidth part (BWP) indicated to a UE (e.g., the UE 116) in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element (CCE)-to-resource element group (REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 v18.0.0 [REF2], or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in TS 38.213 v18.1.0 [REF3].

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 v18.1.0 [REF3] and TS 38.214 v18.1.0 [REF4].

In the following, unless otherwise explicitly noted, providing a parameter value by higher layers includes providing the parameter value by a system information block (SIB), such as a SIB1, or by a common RRC signaling, or by UE-specific RRC signaling.

The following descriptions may take into account that a satellite implements a transparent payload, but are also directly applicable to regenerative payloads.

Throughout this disclosure the terms satellite and UAS platform are used interchangeably, and the following descriptions for satellites can be also directly applicable or adapted for any aerial platform.

The following descriptions and embodiments provide a non-terrestrial network (NTN) but are also directly applicable or adapted to a TN, and the functionalities of a satellite in NTN can be same as the functionalities of a gNB in a TN, or can be adapted taking into account that the footprint of a LEO satellite moves over time because of the movement of the satellite respect to the earth. For a GEO satellite, the footprint is fixed, similar to a gNB in TN.

Throughout this disclosure the terms satellite or serving gNB or gNB are used interchangeably to refer to any component (or collection of components) configured to provide remote terminals with wireless access to a network (e.g., the network 130). Descriptions equally apply to satellite network architectures with transparent payload and with non-transparent payload, thus the gNB can be located at the satellite site or at the NTN gateway site on earth.

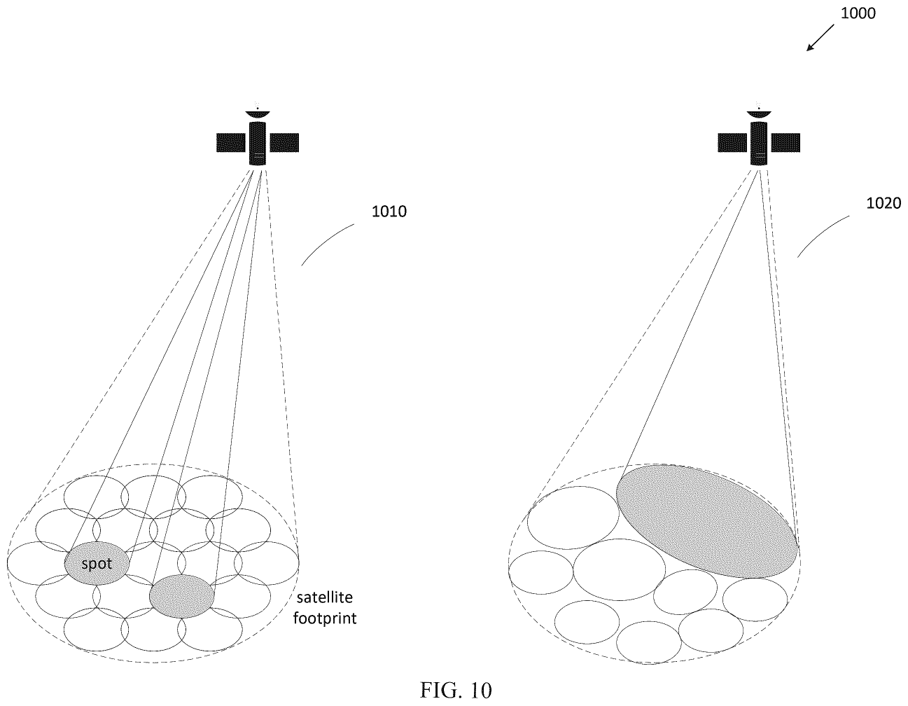

FIG. 10 illustrates diagrams of example satellite footprints 1010 and 1020, respectively, according to embodiments of the present disclosure. For example, satellite footprints 1010 and 1020, respectively, can serve any of the UEs 111-116 of FIG. 1. This example is for illustration only and other embodiments can be used without departing from the scope of the present disclosure.

A non-terrestrial network (NTN) is a network using RF resources on board satellites or unmanned aerial service (UAS) platforms. The NTN includes satellites that can be Geostationary Earth Orbiting (GEO) satellites served by one or several satellite-gateways deployed across the satellites targeted coverage or Low Earth Orbit (LEO) satellites served successively by one or several satellite-gateways at a time, a radio link between a satellite-gateway and the satellite or UAS platform, and a radio link between the UE and the satellite or UAS platform. A satellite or UAS platform may implement either a transparent payload, wherein the NTN payload transparently forwards the radio protocol received from the UE (via the service link) to the NTN Gateway (via the feeder link) and vice-versa, or a regenerative payload with onboard processing. An NTN gateway may serve multiple NTN payloads, and an NTN payload may be served by multiple NTN gateways. The satellite or UAS platform typically generates several beams over a service area or satellite footprint bounded by its field of view. The satellite footprint depends on the onboard antenna diagram and elevation angle. The footprint of a beam or a beam spot can have an elliptic shape and be evaluated for some aspects as a cell in terrestrial networks.

Beams over a satellite footprint can be generated by using multi-feed reflector antennas or phased-array antennas at the satellite. GEO satellites are usually equipped with multi-feed reflector antennas, while phased-array antennas are used for LEO satellites because of their wide-angle coverage capabilities. In order to suppress interference, different frequency bands and orthogonal polarizations may be used for the different beams, and reuse of the frequency bands would be among sufficiently isolated beams to guarantee sufficient system capacity. For LEO satellites, the coverage area and the propagation channel characteristics changes due to the fast movement of the satellites, requiring a fast adaptation of resource allocation for UEs during connected and non-connected modes. Because of the large satellite footprint, traffic can be unequally distributed within the satellite footprint, including areas with high traffic and usually large areas with sparse or no traffic. Limited payload power and feeder link bandwidth limit the number of satellite beams that can be active simultaneously with a nominal equivalent isotropic radiated power (EIRP) density per beam at any given time. Such constraints demand solutions that minimize energy consumption and avoid or at least minimize interference between transmissions or receptions in different beams. Thus, embodiments of the present disclosure recognize that it is necessary to flexibly control resources in the multiple beams of a satellite footprint in time, frequency, space or power domain to optimize performance while maintaining coverage.

One technique that is widely used for controlling transmission power or transmission/reception time interval, as well as antenna direction or frequency band, is beam hopping. Beam hopping can provide an efficient allocation of resources based on dynamic traffic needs within a satellite footprint. As illustrated in FIG. 10, within the satellite footprint there can be a number of cells or spots, and a beam provided by a given NTN-payload can cover one cell or spot. The satellite uses a number of beams over the satellite footprint to serve users in corresponding cells for a given time period. For example, the satellite footprint can include a number N of cells or spots, and the satellite at any given time activates a number M of beams, with M<N, or activates all N beams. When the traffic over the satellite footprint is expected to be approximately equally distributed or when there is a need to provide a same level of coverage in the satellite footprint, the satellite can use beams of approximately same width over the whole footprint. In 1010, the satellite uses beams of same width over the satellite footprint, and over time, the satellite changes the cells that are served by activating different beams in corresponding different areas of the satellite footprint, and beams can hop from one cell to another cell within the satellite footprint. When traffic over the satellite footprint is unequally distributed, the satellite can use beams with different beam widths over different areas of the satellite footprint. In 1020, the satellite uses a large beam over one area of the footprint, for example an area with low traffic, and uses smaller beam widths on other areas with higher traffic. Thus, the satellite can flexibly allocate beam resources in different areas of the satellite footprint and change the distribution of the capacity in different beams over the satellite footprint. Adaptation of the beams within the satellite footprint is subject to a total transmit power of the satellite, and the beam hopping technique is often referred to as power sharing. The total transmit power of the satellite depends on the type of satellite and on configuration that may allow different settings in one or more of time/frequency/spatial domains.

Throughout this disclosure the term beam hopping is generally used to indicate the operation of adapting beams over the satellite footprint in one or more of time/frequency/spatial/power domains, including switching on and off a beam, or using beams with different widths, or using different beams for different control or data channels over a same area or a partially overlapping area.

Present non-terrestrial networks have limited capability to dynamically adapt a beam within a satellite footprint based on the traffic demand. Adaptation is typically over long time periods, or fixed over a given area. Also, present terrestrial networks have limited capability to dynamically adapt a beam towards an area within the cell aiming at serving multiple users in the area based on traffic demand.

Therefore, a capability of a satellite to improve service or to save energy by a dynamic adaptation of a beam to the traffic types and load, for example switching on and off beams or adapting the transmission power of the beam is currently limited as there are limited procedures for the satellite to perform dynamic adaptation based on location information within the satellite footprint or the serving. Although the following embodiments are described with reference to NTN, they are directly applicable to any network including a terrestrial network (TN) and then reference to a satellite can be replaced with reference to a gNB.

Before connecting to an NTN cell, a UE should have valid global navigation satellite system (GNSS) position, as well as have received valid ephemeris and Common TA parameters broadcasted by the network for the serving cell. To achieve synchronization, before and during connection to an NTN cell, the UE determines the round-trip time (RTT) between UE and the Reference Point (RP) based on the GNSS position, the ephemeris, and the Common TA parameters, and autonomously pre-compensates the Timing Advance T_{TA} for the RTT between the UE and the RP as illustrated in FIG. 16.14.2.1-1 of clause 16.14.2 of 3GPP TS 38.300 v18.0.0. The T_{TA} is the time interval between the start of an uplink frame and the start of a corresponding downlink frame and is given by T_{TA}=(N_{TA}+N_{TA,offset}+N_{TA,adj}^{common}+N_{TA,adj}^{UE})T_{c} (clause 4.3.1 of 3GPP TS 38.211 [REF1]), wherein N_{TA,offset} t is based on K_{offset}=K_{cell,offset}−K_{UE,offset}, where K_{cell,offset} is provided by cellSpecificKoffset and K_{UE,offset} is provided by a Differential K_{offset} MAC CE command; otherwise, if not respectively provided, K_{cell,offset}=0 or K_{UE,offset}=0. To pre-compensate the two-way transmission delay on the service link, the UE determines the N_{TA,adj}^{UE} using higher-layer ephemeris parameters for a serving satellite, if provided, the serving satellite position and its own position. To pre-compensate the two-way transmission delay between the uplink time synchronization reference point and the serving satellite, the UE determines N_{TA,adj}^{common} based on one-way propagation delay

$${Delay}_{common} ( t ) = \frac{{TA}_{Common}}{2} + \frac{{TA}_{CommonDrift}}{2} \times ( t - {t}_{epoch} ) + \frac{{TA}_{CommonDriftVariant}}{2} \times {( t - {t}_{epoch} )}^{2}$$

where TA_{Common}, TA_{CommonDrift}, and TA_{CommonDriftVariant} are respectively provided by ta-Common, ta-CommonDrift, and ta-CommonDriftVariant and t_{epoch} is provided by epochTime which is the epoch time of ta-Common, ta-CommonDrift, and ta-CommonDriftVariant. Delay common (t) provides a distance at time t between the serving satellite and the uplink time synchronization reference point divided by the speed of light. The uplink time synchronization reference point is the point where DL and UL are frame aligned with an offset given by N_{TA,offset}. The UE also determines the frequency Doppler shift of the service link, and autonomously pre-compensates for it in the uplink transmissions, by considering the UE position and the ephemeris. If the UE does not have a valid GNSS position and/or valid ephemeris and Common TA, the UE does not transmit until both are reacquired. In connected mode, the UE continuously updates the Timing Advance and frequency pre-compensation. The UE can be configured to report Timing Advance during random access (RA) procedures or in connected mode. In connected mode, Timing Advance reporting can be event-triggered. Upon network request, the UE reports its coarse UE location information (most significant bits of the GNSS coordinates, ensuring an accuracy in the order of 2 km) to the NG-RAN if available.

A satellite would provide coverage over a certain area by transmitting multiple synchronization signal/physical broadcast channel (SS/PBCH) blocks with different beams associated with respective quasi-collocation properties, and the UE typically would acquire the SS/PBCH block associated with the quasi-collocation properties that best match the ones of the UE. Then, expecting beam reciprocity for the DL and UL transmissions, the UE transmits PRACH according to a spatial setting that is determined from the detected SS/PBCH block. The network transmits a SS/PBCH block with a wide beam to cover a corresponding wide area on the satellite footprint, while the UE, to compensate for a DL/UL coverage imbalance, would typically transmit a PRACH with a narrower beam that is unknown to the satellite. The UE location is also unknown to the satellite.

In order to optimize beam hopping and enable a network to flexibly allocate beam resources in areas within the satellite footprint where UEs are present, a satellite can acquire knowledge of a presence of UEs in an area of the satellite footprint by sending an early indication over the area using a beam. The early indication (EI) is a way for the network to discover or sense whether UEs are present in a certain area, thus the early indication is also referred as a discovery indication (DI) or a sensing indication (SI). UEs that are camping in the area and are in RRC_IDLE state or in RRC_INACTIVE state would respond to reception of the early indication by sending an acknowledgment of reception of the early indication, and the satellite would ensure to provide coverage in the area through the same beam or through a different beam from the beam used to transmit the early indication. Information related to parameters for the transmission of EI can be provided on a different beam or on a different cell, for example by system information. Based on responses provided by the UEs, the satellite adapts beams over the satellite footprint, transmits system information over the area, and provides resources for random access by the UE. Each beam over a respective area of the satellite footprint can be regarded as a cell, thus a gNB (e.g., the gNB 102) or satellite, based on the presence of UEs in the cell, adapts the cell coverage by adapting beam resources and/or transmit power and/or configurations over a time period. For example, in an area of the satellite footprint where UEs have provided an acknowledgement of the early indication, the satellite adapts resources for allowing UEs to access the network, for example by transmitting system information enabling the UE to camp on the area or the cell and to possibly perform initial access. In an area or a cell of the satellite footprint from where no acknowledgement of the early indication was received by the satellite or gNB, or negative acknowledgments were received, the satellite may switch off the beam used for providing coverage in that area for a certain time period, for example by stopping transmission of system information, or may adapt the beam to cover a smaller or larger area (smaller/larger beamwidth), or may vary the transmit power of downlink signals or channels within the beam. Additionally, or alternatively to adapting the beam width and/or the transmit power based on the presence of UEs in an area of the satellite footprint or on the reception of an EI response or on an absence of an EI response within a time interval, the satellite can also adapt a configuration of SS/PBCH blocks. For example, the gNB can adapt a periodicity of SS/PBCH blocks, or a duration of the discovery burst transmission window provided per serving cell by discoveryBurstWindowLength, or a periodicity of the discovery burst transmission window, or SS/PBCH block indexes provided by ssb-PositionsInBurst, or a number N of SS/PBCH block indexes associated with one PRACH occasion and a number R of contention based preambles per SS/PBCH block index per valid PRACH occasion by ssb-perRACH-OccasionAndCB-PreamblesPerSSB, or a PRACH mask index provided by ssb-SharedRO-MaskIndex.

When a satellite adapts beams over the satellite footprint, hence adapts the network operation for (a part of) the satellite footprint, the satellite needs to signal the change of network operation. Depending on the type of network operation change, the satellite would notify UEs affected by the change and/or broadcast the notification over (a part of) the satellite footprint. For example, the satellite or the gNB may transmit system information when the satellite or the gNB receives an EI response, or the satellite or the gNB may stop transmission of system information when the satellite or the gNB does not receive any indication of UE presence on the cell associated with the system information.

Therefore, there is a need to define a channel/signal providing an early indication (EI) to UEs over an area of a satellite footprint (or of a serving cell) that would enable a satellite (or a serving gNB) to determine a network operation in the area, including a procedure for beam adaptation.

There is another need for the UE to receive the channel/signal providing EI and, in response, to transmit an acknowledgment to the network.

There is another need to determine a time relation between a reception of the EI and a channel/signal transmission that provides the acknowledgment of EI reception.

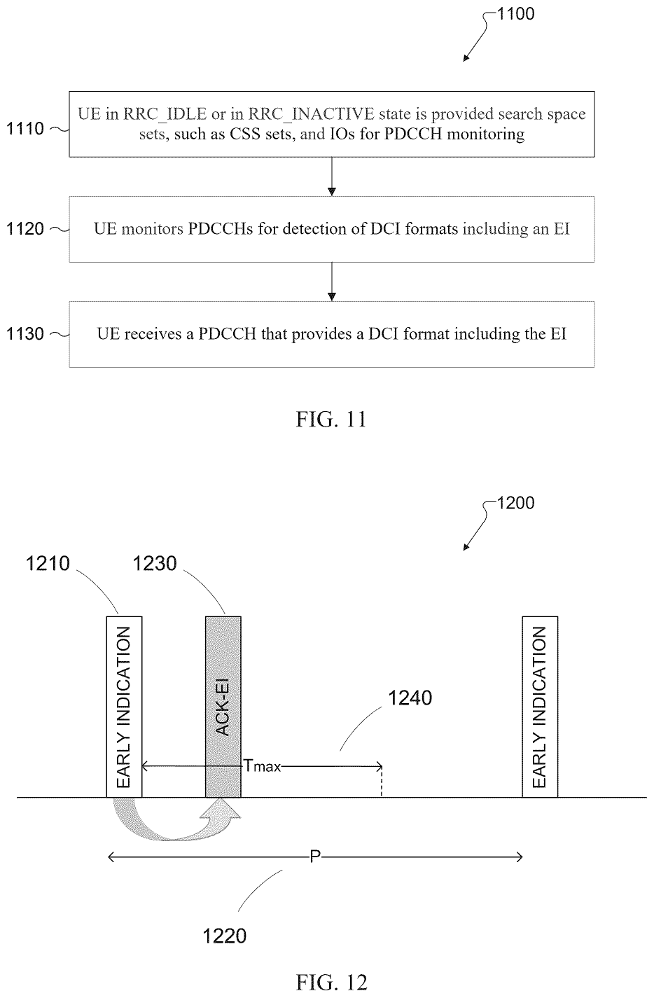

FIG. 11 illustrates a flowchart of an example UE procedure 1100 for receiving an EI according to embodiments of the present disclosure. For example, procedure 1100 for receiving an EI can be performed by any of the UEs 111-116 of FIG. 1, such as the UE 111. his example is for illustration only and other embodiments can be used without departing from the scope of the present disclosure.

The procedure begins in 1110, a UE in RRC_IDLE or in RRC_INACTIVE state is provided search space sets, such as CSS sets, to determine PDCCH monitoring occasions. In 1120, the UE monitors PDCCHs for detection of DCI formats including an EI. In 1130, the UE receives a PDCCH that provides a DCI format including the EI.

An early indication (EI) transmitted from a serving gNB allows the network to reach UEs in RRC_IDLE and in RRC_INACTIVE state and detect a presence of one or more UEs in a cell or in an area of the satellite footprint served by a beam. A satellite usually uses multiple beams to cover the satellite footprint and, based on the presence of UEs, switches on and off beams and/or adapts beam width and transmit power within the beam.

In a first approach, a UE in RRC_IDLE or in RRC_INACTIVE state can be configured to monitor, on a first cell, a PDCCH for detection of a DCI format or a synchronization signal (SS) that includes the EI. When the EI is provided by a DCI format, the UE can also be provided search space sets, such as CSS sets, via system information on a second cell, such as a coverage cell, that is different from the first cell of the PDCCH or SS transmission. For example, the UE can be provided ei-SearchSpace set. When the EI is provided by an SS, the UE can be provided occasions for reception of SS via system information on the second cell. The UE is provided a group of search space sets associated with the monitoring of a group of channels that the UE monitors while in RRC_IDLE and/or in RRC_INACTIVE state, and the UE monitors PDCCH in a slot according to the valid channel in the slot. For a set of channels, a serving gNB can associate indexes of the set of channels with search space sets. For example, when the gNB indicates parameters for search space sets to UEs, the parameters can include indexes from the set of channels for which the search space set is applicable. For example, when the gNB indicates sequences for SS transmissions on the first cell, the parameters can include indexes of channels for which a sequence from the sequences that is used to transmit the SS is applicable. For the monitoring of a first channel, the UE monitors PDCCH according to a search space set if the index of the first channel is included in the configuration of the search space set or if the UE detects a SS with a sequence associated with the first channel. Examples of channels that the UE would monitor while in RRC_IDLE and/or in RRC_INACTIVE state besides EI are paging channel or early paging channel.

When a UE is provided a search space set to monitor PDCCH for detection of a DCI format, or sequences to monitor a SS, including an EI, the UE can be also provided a number of frames or slots, or generally a time offset, to determine the first frame or slot that includes at least one monitoring occasion for a PDCCH reception or a SS reception, a number of symbols from the start of the frame or slot to determine the first monitoring occasion, or a number of Indication Occasions (IOs) that are associated with the monitoring occasions. The UE can also be provided a monitoring periodicity that indicates the number P of symbols or slots between two consecutive IOs. The DCI format can be a DCI format n1_n2, such as DCI format 5_0 or a DCI format 2_7a, with CRC scrambled by EI-RNTI, and is used for notifying the early indication for one or more UEs. When DCI format n1_n2 is associated with CSS sets, IOs for PDCCH monitoring can be common for a group of UEs, including UEs with a same serving gNB, and a time offset to determine the IOs can be provided by a SIB.

In various embodiments, any or all of the information provided to the UE to indicate reception information for the EI (or SS, PDCCH, DCI, etc.) may be provided in system information on a second cell that is different than a first cell of the PDCCH or SS reception. Further, the EI triggering the presence detection may be a first signal that is a SS with on-off keying (OOK) modulation, a SS that is same as a SS in a SS/PBCH block, or a tracking reference signal (TRS). This first signal may be received by the UE to trigger the UE to transmit a second signal on the first cell for the gNB to determine the presence of the UE that is/was in the RRC IDLE state. For example, the second signal may be a PRACH signal. In various embodiments, the second signal may be transmitted by the UE at a predetermined time after reception of the first signal or at a time indicated by information from higher layers, such as system information, on the second cell. Parameters for the second signal or channel transmission on the first cell can also be indicated by higher layers, such as by system information, on the second cell. In response to a reception of the second signal, the satellite or the gNB can transmit system information on the first cell. In response to an absence of reception of the second signal, the satellite or the gNB can stop transmitting system information on the first cell.

In order to reduce a probability that a UE does not detect a PDCCH with EI information by the serving gNB or a signal with EI information, multiple corresponding IOs can be associated with a PDCCH monitoring occasion for DCI format n1_n2 or with a monitoring occasion for the signal such as a SS. If the UE uses Discontinuous Reception (DRX) in RRC_IDLE or RRC_INACTIVE state in order to reduce power consumption, the UE monitors a first number of IOs per DRX cycle, and the first number can be one or larger than one, and can depend on a configuration. An IO can be a single monitoring occasion for a PDCCH or a SS, or can be a set of monitoring occasions over multiple slots for a PDCCH or a SS.

A UE can monitor a PDCCH or an SS for EI detection in an initial DL BWP that is expected to be smaller than or equal to the active DL BWP after the UE (re) establishes dedicated RRC connection or smaller than or equal to the maximum DL bandwidth that the UE supports.

A UE can monitor a PDCCH or an SS for EI detection in a DL BWP that is same as or different from the DL BWP used to monitor a paging channel or an early paging channel.

In one example, the DL BWP where the UE monitors the PDCCH or the SS for EI detection is the same as the DL BWP that includes SS/PBCH blocks during the random access procedure.

In one example, the DL BWP where the UE monitors the PDCCH or the SS for EI detection is the same as the DL BWP that includes the SS/PBCH blocks that the UE used to obtain SIB1 and, for SS/PBCH block and CORESET multiplexing pattern 1, the CORESET with index 0.

In one example, the DL BWP where the UE monitors the PDCCH or the SS for EI detection is the same as the DL BWP that includes SS/PBCH blocks provided by NonCellDefiningSSB.

In one example, the DL BWP where the UE monitors the PDCCH or the SS is same as the active DL BWP used in RRC_CONNECTED state unless the UE is provided the active DL BWP by a dedicated RRC configuration.

The DL BWP where the UE monitors the PDCCH or the SS for EI detection is different from the DL BWP that includes the SS/PBCH blocks that the UE used to obtain SIB1 and, for SS/PBCH block and CORESET multiplexing pattern 1, the CORESET with index 0; or from the DL BWP that includes SS/PBCH blocks provided by NonCellDefiningSSB; or from DL BWP where the UE monitors the PDCCH or the SS is same as the active DL BWP used in RRC_CONNECTED state unless the UE is provided the active DL BWP by a dedicated RRC configuration.

With reference to FIG. 11, an example procedure is shown for a UE in RRC_IDLE or RRC_INACTIVE state to receive a PDCCH or a SS with EI information according to the disclosure.

In a second approach, a transmission of EI signaling by a serving gNB can be based on on-off keying modulation where the transmission indicates a request for a UE to respond. The EI signalling is broadcasted over a cell or over an area of the satellite footprint served by a beam. The transmission of the EI signaling can have a periodicity and the UE monitors for reception according to a configured monitoring periodicity that indicates the number P of symbols or slots between two consecutive Indication Occasions (IOs) for the EI signaling. The UE can be provided an offset in number of frames and/or symbols to determine the first frame that includes the EI signaling, and the symbol(s) within the frames that include the EI signaling that are referred as IOs and are associated with the EI monitoring occasions. The UE can also be provided a number of IOs per frame or per slot. The IOs for EI monitoring can be common for a group of UEs, including UEs with a same serving gNB or within an area of the satellite footprint served by a same beam.

FIG. 12 illustrates an example timeline 1200 for transmission/reception of an EI according to embodiments of the present disclosure. For example, timeline 1200 can be followed by any of the UEs 111-116 of FIG. 1, such as the UE 112. This example is for illustration only and other embodiments can be used without departing from the scope of the present disclosure.

With reference to FIG. 12, timing relationships are shown for reception of an EI and a transmission of a response to the EI reception. A UE monitors for reception of the EI 1210 with a monitoring periodicity P 1220. After reception of the EI, the UE transmits an acknowledgment of the EI reception (ACK-EI) 1230 within a time interval Tₘₐₓ 1240.

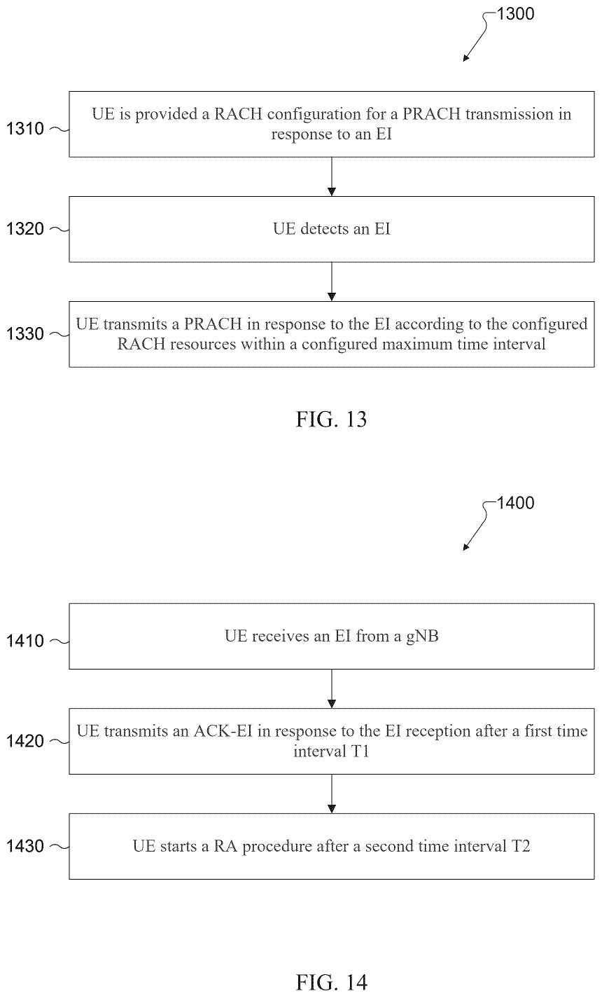

FIG. 13 illustrates a flowchart of an example UE procedure 1300 for transmitting PRACH according to embodiments of the present disclosure. For example, procedure 1300 can be performed by the UE 116 of FIG. 3. This example is for illustration only and other embodiments can be used without departing from the scope of the present disclosure.

The procedure begins in 1310, a UE is provided a random access channel (RACH) configuration for a PRACH transmission in response to an EI. In 1320, the UE detects an EI. In 1330, the UE transmits a PRACH in response to the EI according to the configured RACH resources within a configured maximum time interval.

FIG. 14 illustrates a flowchart of an example UE procedure 1400 for starting a random access procedure according to embodiments of the present disclosure. For example, procedure 1400 can be performed by any of the UEs 111-116 of FIG. 1, such as the UE 115. This example is for illustration only and other embodiments can be used without departing from the scope of the present disclosure.

The procedure begins in 1410, a UE receives an EI from a gNB. In 1420, the transmits an ACK-EI in response to the EI reception after a first time interval T1. In 1430, the UE starts a RA procedure after a second time interval T2.

Upon reception of an EI, a UE (e.g., the UE 116) in RRC_IDLE and/or in RRC_INACTIVE state transmits a response to a serving gNB to acknowledge reception of the EI that is interpreted by the serving gNB as a request to maintain network (e.g., the network 130) operation in the area over which the EI is transmitted. Absence of an acknowledgment reception in response to the EI transmission indicates no such request. The serving gNB transmits the EI information using a beam and would receive responses from UEs in RRC_IDLE and/or in RRC_INACTIVE state present in the area served the beam. The response by the UE is transmitted after a time interval from the frame or slot or (last) symbol of the EI reception, and the time interval is set by a configuration from the gNB or can be predetermined in the specifications of the system operation. The configured time interval can be a maximum time interval for the UE to respond to the EI reception, and the UE can transmit a response within the maximum time interval. The maximum time interval can be provided, for example by system information, as number of frames or slots and is applied after the frame or slot where the EI is received by the UE, respectively. When the EI is provided by a DCI format and the UE monitors PDCCHs for detection of the DCI format, or when the EI is provided by an SS, the time interval Tₘₐₓ starts from the from a slot where the UE starts monitoring PDCCHs or starts monitoring the SS. Alternatively, the time interval Tₘₐₓ starts from the from a slot corresponding to an end of a time window where the UE monitors PDCCH or SS for detection of the EI.

After reception of an EI, a UE in RRC_IDLE and/or in RRC_INACTIVE informs a serving gNB of the reception by transmitting an ACK-EI information. The ACK-EI information can be based on on-off keying modulation where a transmission indicates an acknowledgment of reception of the EI and absence of transmission indicates no such acknowledgment. For example, an ACK-EI can be provided by a PRACH transmission as described in TS 38.213 v18.1.0 [REF3]. The UE can be provided by higher layers, such as by system information, a configuration for a PRACH transmission including a set of SS/PBCH block indexes that are mapped to valid PRACH occasions; a configuration of PRACH transmission parameters including PRACH preamble format, time resources and frequency resources for PRACH transmission, and parameters for determining the root sequences and their cyclic shifts in the PRACH preamble sequence set; a number of SS/PBCH block indexes associated with a PRACH occasion and a number of contention based preambles per SS/PBCH block index per valid PRACH occasion; and a number of preamble repetitions for the PRACH transmission if the UE would transmit the PRACH with repetitions. The gNB can partition RACH resources in a cell, and configure a first partition for use by UEs that provide an ACK-EI and a second partition for use by UEs that start a RA procedure. When the UE transmits a PRACH using RACH resources from the first partition, the UE may not expect to attempt to detect a DCI format in response to the PRACH transmission that schedules a PUSCH transmission associated with an initial access procedure, such as a Msg3 transmission.

With reference to FIG. 13, an example procedure is shown for a UE in RRC_IDLE or RRC_INACTIVE state to transmit an ACK-EI in response to a reception of an EI according to the disclosure.

After reception of the EI, the UE starts a RA procedure by selecting RACH resources from the second partition. Whether to transmit only an acknowledgment of the EI reception without starting a RA procedure, or to start a RA procedure can be autonomously decided by the UE or can depend on an indication by the serving gNB. In one example, based on a configuration in response to a reception of an EI, a UE transmits an acknowledgment of the EI reception, or the UE starts a RA procedure. In another example, the EI includes information on whether, upon reception of the EI, the UE is expected to send an acknowledgment of the reception of the EI or the UE is expected to start a R.A procedure.

In a first example, before a transition from a first network operation mode or state to a second network operation mode or state, the gNB transmits an EI to trigger a RA procedure upon reception of the EI for UEs in RRC_IDLE or RRC_INACTIVE state in the cell or in a coverage area served by a beam within a satellite footprint. When the UEs are in RRC_CONNECTED state, the gNB starts procedures for transitioning from the first network operation mode or state to the second operation mode or state, wherein the procedures for transitioning may affect some or all of the UEs in the cell or in the coverage area served by the beam within the satellite footprint and transmits a notification to the UEs.

In a second example, before a transition from a first network operation mode or state to a second network operation mode or state, the gNB (e.g., the gNB 102) transmits a first EI to trigger a transmission of an acknowledgment upon reception of the first EI by the UEs in RRC_IDLE or RRC_INACTIVE state within the cell or coverage of a beam within a satellite footprint, and may additionally transmit a second EI to trigger a RA procedure upon reception of an acknowledgment of the first EI.

When a UE receives an EI, whether the UE transmits an acknowledgment of the EI reception or starts a RA procedure can be subject to a configuration of the EI, or to a UE capability, or a quality of the EI reception. For example, when the EI is configured as a trigger for starting a RA procedure, if the UE receives the EI with a good quality (for example reception with a power level above a threshold) the UE starts a RA; otherwise, the UE transmits an acknowledgment of the EI reception. Additionally, the UE may attempt to start the RA procedure after transmitting the acknowledgment of the EI, within a configured time interval from the reception of the EI.

With reference to FIG. 14, an example procedure is shown for a UE in RRC_IDLE or RRC_INACTIVE state to respond to a reception of an EI according to the disclosure.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving first information indicating reception occasions for a first signal or a first channel on a first cell;
receiving second information indicating resources for transmission of a second signal or a second channel on the first cell;
receiving the first signal or the first channel on the first cell;
determining to transmit the second signal or the second channel on the first cell based on the reception of the first signal or channel; and
transmitting the second signal or the second channel using a resource from the resources on the first cell, and
receiving first system information on the first cell after the transmission of the second signal or the second channel.

2. The method of claim 1, wherein:
the first signal is a synchronization signal with on-off keying (OOK) modulation, and
the first information is provided by system information on a second cell.

3. The method of claim 1, wherein:
the first signal is a synchronization signal with orthogonal frequency division modulation (OFDM), and
the first information is provided by system information on a second cell.

4. The method of claim 1, wherein the first information includes a periodicity for the reception occasions.

5. The method of claim 1, wherein:
the second channel is a physical random access channel (PRACH), and
the second information is provided by system information on a second cell.

6. The method of claim 1, wherein the transmission of the second signal or the second channel is at a resource, from the resources, that is after the reception of the first signal or the first channel by a time indicated in the second information.

7. The method of claim 1, wherein the transmission of the second signal or the second channel is at a resource, from the resources, that is after the reception of the first signal or the first channel by a predetermined time.

8. A user equipment (UE) comprising:
a transceiver configured to:
receive first information indicating reception occasions for a first signal or a first channel on a first cell, receive second information indicating resources for transmission of a second signal or a second channel on the first cell, and
receive the first signal or the first channel on the first cell; and
a processor operably coupled to the transceiver, the processor configured to determine an indication for transmission of the second signal or the second channel on the first cell based on the reception of the first signal or channel on the first cell,
wherein the transceiver is further configured to:
transmit the second signal or the second channel using a resource from the resources on the first cell, and
receive first system information on the first cell after the transmission of the second signal or the second channel.

9. The UE of claim 8, wherein:
the first signal is a synchronization signal with on-off keying (OOK) modulation, and
the first information is provided by system information on a second cell.

10. The UE of claim 8, wherein:
the first signal is a synchronization signal with orthogonal frequency division modulation (OFDM), and
the first information is provided by system information on a second cell.

11. The UE of claim 8, wherein the first information includes a periodicity for the reception occasions.

12. The UE of claim 8, wherein:
the second channel is a physical random access channel (PRACH), and
the second information is provided by system information on a second cell.

13. The UE of claim 8, wherein the transmission of the second signal or the second channel is at a resource, from the resources, that is after the reception of the first signal or the first channel by a time indicated in the second information.

14. The UE of claim 8, wherein the transmission of the second signal or the second channel is at a resource, from the resources, that is after the reception of the first signal or the first channel by a predetermined time.

15. A base station comprising:
a transceiver configured to:
transmit first information indicating reception occasions for a first signal or a first channel on a first cell,
transmit second information indicating resources for reception of a second signal or a second channel on the first cell,
transmit the first signal or the first channel on the first cell, and
receive the second signal or channel on the first cell; and
a processor operably coupled to the transceiver, the processor configured to:
determine a presence or an absence of a user equipment (UE) operating in a radio resource control (RRC) IDLE state based on the reception of the second signal or channel, and
instruct the transceiver to transmit first system information upon determining the presence.

16. The base station of claim 15, wherein:
the first signal is a synchronization signal with on-off keying (OOK) modulation, and
the first information is provided by system information on a second cell.

17. The base station of claim 15, wherein:
the first signal is a synchronization signal with orthogonal frequency division modulation (OFDM), and
the first information is provided by system information on a second cell.

18. The base station of claim 15, wherein:
the second channel is a physical random access channel (PRACH), and
the second information is provided by system information on a second cell.

19. The base station of claim 15, wherein the transmission of the second signal or the second channel is at a resource, from the resources, that is after the reception of the first signal or the first channel by a time indicated in the second information.

20. The base station of claim 15, wherein the reception of the second signal or the second channel is at a resource, from the resources, that is after the transmission of the first signal or the first channel by a predetermined time.
